(19) United States
(12) Patent Application Publication
(10) Pub. No.: US 2026/0051207 A1
(43) Pub. Date: Feb. 19, 2026

(54) METHOD FOR OPERATING AN INTERNAL COMBUSTION ENGINE, AND INTERNAL COMBUSTION ENGINE

(71) Applicant: Dr. Ing. h.c. F. Porsche Aktiengesellschaft, Stuttgart (DE)

(72) Inventor: Holger Wöhr, Weissach (DE)

(73) Assignee: Dr. Ing. h.c. F. Porsche Aktiengesellschaft, Stuttgart (DE)

(21) Appl. No.: 19/302,534

(22) Filed: Aug. 18, 2025

(30) Foreign Application Priority Data
Aug. 19, 2024 (DE) 102024123562.4

(51) Int. Cl. G07C 5/08; F02D 41/00

(52) U.S. Cl. CPC G07C 5/0816; F02D 41/0025

(57) ABSTRACT

A method for operating an internal combustion engine. A torque emitted from the internal combustion engine is determined by a torque model based on operating parameters of the internal combustion engine. Using a water injection system, water is injected into an intake tract of the internal combustion engine. A corrective parameter is determined using the torque model based on the amount of water injected by the water injection system. An internal combustion engine includes the water injection system and a control unit is configured so as to carry out the method for operating the internal combustion engine.

### CROSS REFERENCE TO RELATED APPLICATION

This application claims priority to German Patent Application No 10 2024 123 562.4, filed Aug. 19, 2024, the content of such application being incorporated by reference herein in its entirety.

### FIELD OF THE INVENTION

The present invention relates to a method for operating an internal combustion engine, wherein a torque emitted from the internal combustion engine is determined by means of a torque model based on operating parameters of the internal combustion engine. The present invention further relates to an internal combustion engine having a control unit configured so as to carry out such a method.

### BACKGROUND OF THE INVENTION

It is well known in the motor vehicle field to use a torque model to determine or estimate a torque emitted from an internal combustion engine of the motor vehicle as a function of operating parameters of the internal combustion engine. Thus, it is not necessary to actually measure the torque emitted from the internal combustion engine.

For example, a reliable and accurate modeling of the torque emitted from the internal combustion engine is critical in order to enable as smooth a shifting as possible of a transmission coupled to the internal combustion engine.

A determination of a torque emitted from an internal combustion engine based on operating parameters of the internal combustion engine by means of a torque model is described, for example, in DE 10 2012 012 341 A1, which is incorporated by reference herein.

### SUMMARY OF THE INVENTION

The present invention enhances the reliability of operation of a high-performance and/or consumption-optimized internal combustion engine.

In the method according to aspects of the invention for operating an internal combustion engine, a torque emitted from the internal combustion engine is determined or calculated in a manner known per se by means of a torque model typically stored in or programmed into an engine control unit based on operating parameters of the internal combustion engine. The torque model typically comprises at least one map, preferably a plurality of maps. The operating parameters can be, for example, an ignition angle, an air charge, a lambda value, an injection mode, an injection amount, an engine speed, a temperature, a cam setting, and/or an ignition setting.

In the method according to aspects of the invention for operating an internal combustion engine, in order to reduce emissions, reduce fuel consumption, and/or increase power, water is further injected into an intake tract of the internal combustion engine by means of a water injection system which is configured in a manner known per se.

Due to the fact that, by injecting water, the combustion process in the internal combustion engine is “delayed,” the method according to aspects of the invention for operating an internal combustion engine determines the amount of water emitted from the internal combustion engine based on an amount of water injected by the water injection system. The amount of water injected by the water injection system is thus used as an additional input parameter for the torque model according to aspects of the invention. Specifically, according to aspects of the present invention, a corrective parameter is determined by the torque model based on the amount of water injected by the water injection system, which reflects influences of the combustion delayed by the water injection on the torque model. This allows in a relatively simple manner to account for the influence of water injection when determining the torque emitted from the internal combustion engine, and thus allows for a reliable and accurate determination of the torque emitted from the internal combustion engine, even when using a water injection system, and thus a reliable operation of a high-performance and/or consumption-optimized internal combustion engine.

Preferably, the corrective parameter determined by the torque model is a torque offset value that directly reflects a change in the torque emitted from the internal combustion engine due to the combustion delayed by water injection. The torque offset value is greater the larger the amount of water injected by the water injection system. This allows, in a particularly straightforward manner, to account for the influence of the water injection when determining the torque emitted from the internal combustion engine.

The internal combustion engine according to aspects of the invention comprises a water injection system configured in a manner known per se. The water injection system comprises at least one injection nozzle configured so as to inject water into an intake tract of the internal combustion engine, preferably into a so-called suction tube of the internal combustion engine. Preferably, the water injection system comprises a number of injection nozzles corresponding to the number of cylinders of the internal combustion engine, each configured so as to inject water into the suction tube of one of the cylinders. The water injection system typically comprises a pump configured so as to convey water from a water tank via water lines to the at least one injection nozzle.

The internal combustion engine according to aspects of the present invention further comprises a control unit configured so as to carry out a method according to aspects of the present invention for operating an internal combustion engine. Preferably, the control unit is realized by suitable programming of an engine control unit of the internal combustion engine.

By carrying out the method according to aspects of the invention, the control unit enables a reliable operation of a high-performance and/or consumption-optimized internal combustion engine for the aforementioned reasons.

### BRIEF DESCRIPTION OF THE DRAWING

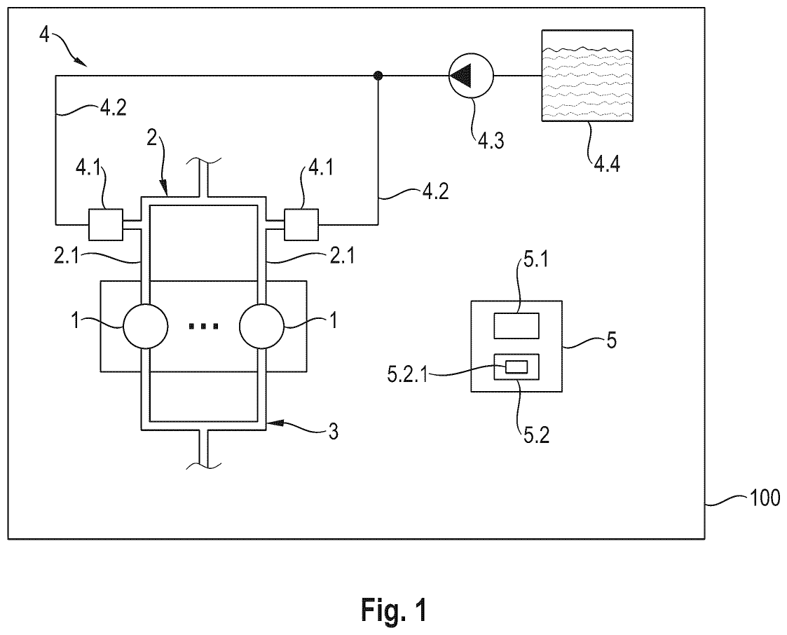

An example embodiment of the present invention is described below on the basis of the attached FIG. 1, which shows a schematic diagram of an internal combustion engine according to aspects of the invention.

### DETAILED DESCRIPTION OF THE INVENTION

FIG. 1 shows an internal combustion engine 100 according to aspects of the present invention, having a plurality of cylinders 1, an intake tract 2, and an exhaust tract 3, wherein the plurality of cylinders 1 are each connected to the intake tract 2 for supplying combustion air and to the exhaust tract 3 for dissipation of exhaust gas.

The internal combustion engine 100 further comprises a water injection system 4 having a number of injection nozzles 4.1 corresponding to the number of cylinders 1, each configured so as to inject water provided via a water line 4.2 into the intake tract 2, specifically into a suction tube 2.1 associated with the cylinder 1.

The water injection system 3 further comprises a pump 4.3 and a water tank 4.4, wherein the pump 4.3 is configured so as to supply water from the water tank 4.4 to the injection nozzles 4.1 via the water lines 4.2 at a defined water pressure.

The internal combustion engine 100 further comprises a control unit 5 having a water injection control module 5.1 and a torque modeling module 5.2, in which a torque model 5.2.1 designed in a manner known per se is stored. The control unit 4 may be a computer having a processor, a memory containing programming instructions for operation of the control unit, and a controller, for example.

The water injection control module 5.1 is configured so as to inject a defined amount of water into the intake tract 2 via the water injection system 3 and to provide the information about the respective amount of water as an input parameter for the torque model 5.2.1 to the torque modeling module 5.2.

The torque modeling module 5.2 is configured so as to determine, or calculate, a torque emitted from the internal combustion engine 100 by means of the stored torque model 5.2.1 based on the information provided about the respective amount of injected water as well as based on further operating parameters of the internal combustion engine 100.

In order to determine the torque emitted from the internal combustion engine 100, the torque modeling module 5.2 is specifically configured so as to determine a corrective parameter, specifically a torque offset value, based on the information provided about the amount of water injected, and to settle it against a torque value determined in a manner known per se based on the remaining operating parameters of the internal combustion engine 100.

### LIST OF REFERENCE NUMERALS

100 Internal combustion engine
1 Cylinder
2 Intake tract
2.1 Suction tubes
3 Exhaust tract
4 Water injection system
4.1 Injection nozzles
4.2 Water lines
4.3 Pump
4.4 Water tank
5 Control unit
5.1 Water injection control module
5.2 Torque modeling module
5.2.1 Torque model

What is claimed is:

1. A method for determining a torque emitted from an internal combustion engine using a torque model that is based on operating parameters of the internal combustion engine, said method comprising:
injecting water into an intake tract of the internal combustion engine using a water injection system, and
determining a corrective parameter for the torque using the torque model based on an amount of water injected by the water injection system.

2. The method according to claim 1, wherein the corrective parameter is a torque offset value.

3. The method according to claim 1, further comprising determining the torque based at least in part on the corrective parameter and said operating parameters.

4. The method according to claim 1, further comprising operating a transmission connected to the internal combustion engine based on the determined torque.

5. An internal combustion engine comprising:
a water injection system; and
a control unit configured to determine a torque emitted from the internal combustion engine using a torque model that is based on operating parameters of the internal combustion engine, the control unit being configured to:
(i) inject water into an intake tract of the internal combustion engine using the water injection system, and
(ii) determine a corrective parameter for the torque using the torque model based on an amount of water injected by the water injection system.
